(19) United States
(12) Patent Application Publication
(10) Pub. No.: US 2007/0043705 A1
(43) Pub. Date: Feb. 22, 2007

(54) Searchable backups

(75) Inventors: Akhil Kaushik, Sunnyvale, CA (US); Subramanian Periyagaram, Sunnyvale, CA (US); Jian Xing, Antioch, CA (US); Rangarajan Suryanarayanan, Santa Clara, CA (US)

Correspondence Address: VAN PELT, YI & JAMES LLP, 10050 N. FOOTHILL BLVD #200, CUPERTINO, CA, 95014, US

(73) Assignee: EMC Corporation

(21) Appl. No.: 11/207,606

(22) Filed: Aug. 18, 2005

(51) Int. Cl. G06F 17/30

(52) U.S. Cl. 707/3

(57) ABSTRACT

Facilitating a search of backup data is disclosed. Data associated with at least a portion of the backup data is received. A searchable index of the backup data is generated based at least in part on the received data. The searchable index includes an index data indicating a location within the backup data of an object comprising the backup data.

### BACKGROUND OF THE INVENTION

Restoring a specific file, directory, or other object from backup data currently typically requires determining an appropriate backup source (e.g., a specific backup tape with the desired file), using the backup source to restore an associated data set (e.g., a set of production data as it existed at a time at which a backup operation associated with the backup source was performed), and searching or browsing to determine if the desired file or other object is present in the restored data set. This retrieval based process can be inefficient and time consuming, particularly if there are multiple backup sources and/or backup sources of more than one type. Therefore, there exists a need to efficiently search and restore files from backup data sources.

### BRIEF DESCRIPTION OF THE DRAWINGS

Various embodiments of the invention are disclosed in the following detailed description and the accompanying drawings.

FIG. 1 is a block diagram illustrating an embodiment of a search enabled backup restoration environment.

FIG. 2 is a block diagram illustrating the flow of data in an embodiment of a search enabled backup restoration environment.

FIG. 3A is a flow chart illustrating an embodiment of a process for searching and retrieving backup data.

FIG. 3B is a flow chart illustrating an embodiment of a process for preparing backup data for searching.

FIG. 3C is a flow chart illustrating an embodiment of a process for performing a backup data search.

FIG. 3D is a flow chart illustrating an embodiment of a process for retrieving data from backup data.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Enabling backup data to be searched without accessing the backup data or first using it to restore an associated production data set is disclosed. In some embodiments, backup data is indexed for efficient searching. In some embodiments, indexing includes generating data that can be used to determine whether a data of interest is present in a set of backup data and/or where data of interest is located within a set of backup data. In some embodiments, indexes for multiple sets of backup data are integrated and/or stored together with backup location identifiers indicating for each file or other object the location of associated data within the backup data (e.g., identifying the associated backup data set and a location of the object within that set). In some embodiments, the backup data index is searched to locate a desired file or other object. In some embodiments, search results are provided and include a backup location identifier for each instance or occurrence of an object found in the index. Using the identifier(s), the desired data may be located within the backup data and restored.

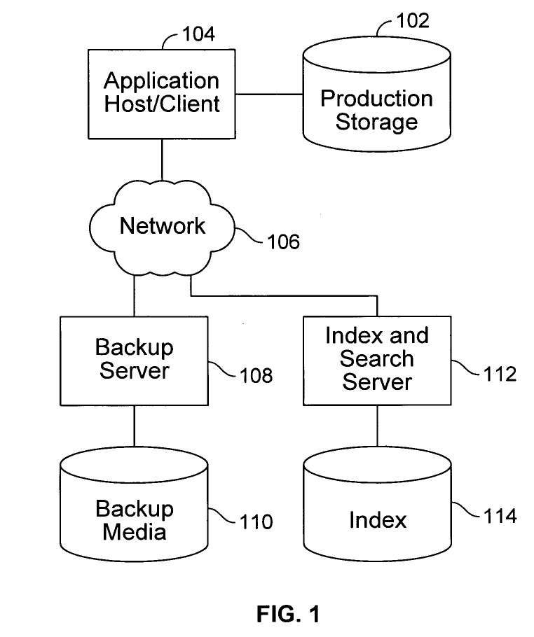

FIG. 1 is a block diagram illustrating an embodiment of a search enabled backup restoration environment. Production storage 102 is connected to application host/client 104. Backup media 110 is connected to backup server 108. Index storage 114 is connected to index and search server 112. Application host/client 104, backup server 108, and index and search server 112 are connected together through network 106. Any number of production storage 102, application host/client 104, backup server 108, backup media 110, index and search server 112, and index storage 114 may exist. Production storage 102, backup media 110, and index storage 114 may be one or more storage mediums, including hard drives, file system partitions, backup tapes, NAS (Network Attached Storage), SAN (Storage Area Network), any optical and magnetic storage medium, and any fixed, removable, or networked storages.

In some embodiments, backup media 110 contains backup data to be restored to production storage 102. In various alternative embodiments, backup media 110 is connected via network 106 to backup server 108 and/or to application host/client 104; is included in and/or connected locally, e.g., via a direct or storage area network connection, to application host/client 104; and/or is included in or connected to a storage node or proxy client associated with backup server 110 and/or application host/client 104. In some embodiments, backup media 110 contains data associated with one or more backup operations performed by or under the control or supervision of backup server 108, such as data indicating for each of one or more objects comprising a set of backup data a location of the object within the set of backup data.

In the example shown, application host/client 104 hosts an application and stores associated application data in production storage 102. In some embodiments, production storage 102 stores data to be backed up to backup media 110. In some embodiments, application host/client 104 is configured to perform at least in part a backup operation in which application data stored in production storage 102 is backed up. In some embodiments, an agent installed on application host/client 104 performs or participates in performing a backup of application data stored in production storage 102. Production storage 102 may be a hard drive associated with a personal computer. Application host/client 104 may include a processor associated with a personal computer. Application host/client 104 and production storage 102 may comprise a personal computer.

Backup server 108 facilitates communication between backup media 110 and devices connected to network 106. Backup server 108 may perform processing such as backup coordination and compression. In some embodiments, backup server 108 is a server running EMC Legato NetWorker backup and recovery software available from EMC Corporation of Hopkinton, Mass. In some embodiments, backup server 108 comprises and/or is connected directly or via network 106 to one or more storage nodes that include multiplexing/demultiplexing backup stream capability and/or Universal Proxy Clients that perform various backup processing such as offloading from an application server such as application host/client 104 such tasks as backup, data movement, etc. In some embodiments, backup media 110 may include backup snapshot data, compressed backup data, generational backup data, continuously mirrored and/or backed up data, and backup data in removable storage formats. Index storage 114 stores search data (e.g., index data) associated with backup media 110 and/or production storage 102. Index and search server 112 may create, maintain, search, transfer, and process data associated with index storage 114. Network 106 may be any public or private network and/or combination thereof, including without limitation an Ethernet, serial/parallel bus, intranet, Internet, NAS, SAN, LAN, WAN, and other forms of connecting multiple systems and or groups of systems together. In some embodiments, production storage 102, backup media 110, and/or index storage 114 are connected to network 106 through other data routing paths and/or connected to one or more other systems.

In some embodiments, a search/restore application, agent, or interface running on application host/client 104 or some other host sends a search query to index and search server 112. Server 112 searches, based on the received query, an index stored in index storage 114 and returns search results that include for each of one or more objects that satisfy the query a backup location identifier indicating a corresponding location of the object within a set of backup data associated with the index. In some embodiments, a link, button, or other interface is provided to enable one or more objects identified in the search results to be retrieved. In some embodiments responsive objects are retrieved automatically, without further request or indication. The search/restore application sends to the backup server the location identifier(s) of data to be restored. The backup server retrieves the data to be restored from backup media 110 using the location identifier(s) and sends the retrieved data to the search/restore application for restoration in production storage 102, after which it is available to be accessed and used by an application running on application host/client 104.

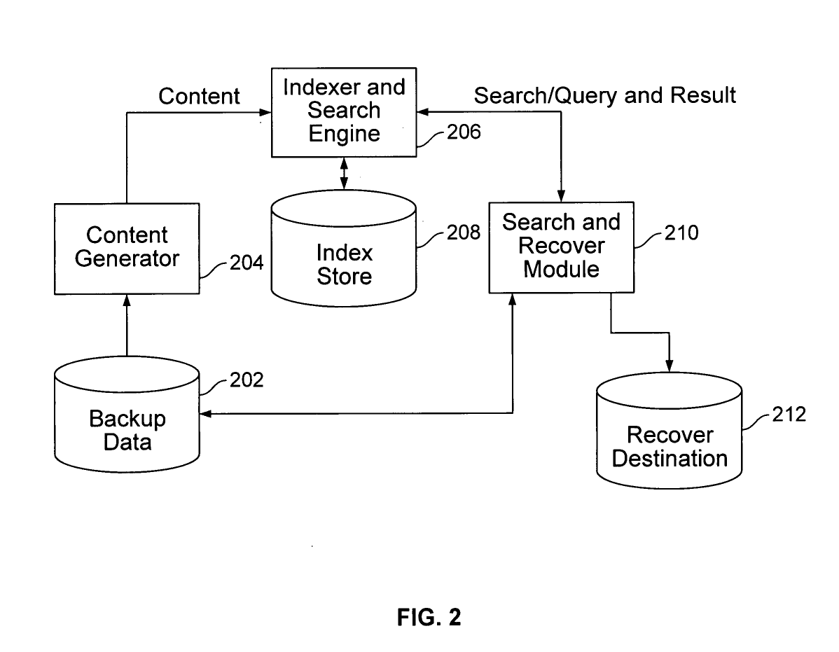

FIG. 2 is a block diagram illustrating the flow of data in an embodiment of a search enabled backup restoration environment. In the example shown, backup data 202 includes backup data that can be used to restore data to recover destination 212. Backup data 202 may include a backup stream generated by a backup application and/or backup data stored on one or more of the following: hard drives, backup tapes, NAS (Network Attached Storage), SAN (Storage Area Network), any optical and magnetic storage medium, and any fixed, removable, or networked storages. Backup data 202 may include one or more of any type of backup data including backup stream, backup-to-disk, backup-to-tape, snapshot, generational backup, and/or backup stream. Content generator 204 processes data comprising and/or associated with backup data 202 for indexing by indexer and search engine 206. Content generator 204 may decompress, convert, translate, and/or transfer data comprising and/or associated with backup data 202 into a format associated with indexer and search engine 206. Content generator 204 may process data from backup data 202 on a prescribed basis, periodically, and/or substantially concurrent with storage of data in backup data 202 and/or generation of backup data 202 by an associated backup process. For example, a pre-existing backup data on a backup system may be used to generate content for indexer and search engine 206. Backup data 202 may be checked periodically for new data to be indexed. As new backups are performed, the new data may be passed to content generator 204 as well as a backup data storage unit. Indexer and search engine 206 receives content from content generator 204 and indexes and prepares the data for searching. Indexing includes any method for processing data for search and retrieval. Indexing and searching software such as FAST InStream available from FAST of Needham, Mass. may be used. In some embodiments, data associated with the indexing and searching is generated and stored in index store 208. In some embodiments, data in index store 208 includes backup location identifiers associated with backup data 202 that indicate locations of associated data, e.g., one or more particular objects, such as a file, directory, or other file system object in the case of backup data associated with a file system backup, in backup data 202. For example, a data entry in index store 208 might include keywords and a unique identifier associated a file or other object in backup data 202. Using the generated index data, indexer and search engine accepts search queries from search and recover module 210. A search associated with a query is performed by engine 206, using index data stored in index store 208, and the results of the query are returned to module 210 along with backup location identifiers associated with responsive portion(s) of backup data 202. Search and recover module 210 in some embodiments coordinates and/or facilitates interaction between engine 206, backup data 202, and recover destination 212. Using the received identifiers in the search result, module 210 communicates to backup data 202 one or more identifiers associated with the desired data to be restored. Backup data 202 retrieves the data associated with the identifiers and returns the desired data to module 210 for data recovery into destination 212. The data may be decompressed, converted, modified, and/or merged before recovery into destination 212. In some embodiments, index store 208 and backup data 202 exists in a same physical storage unit. In some embodiments, recover destination is production storage 102 of FIG. 1. In some embodiments, backup data 202 and recover destination 212 are same physical storage units.

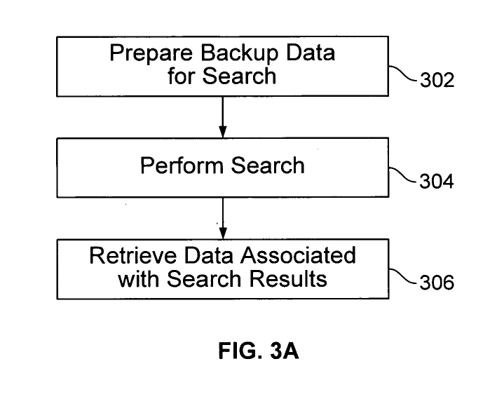

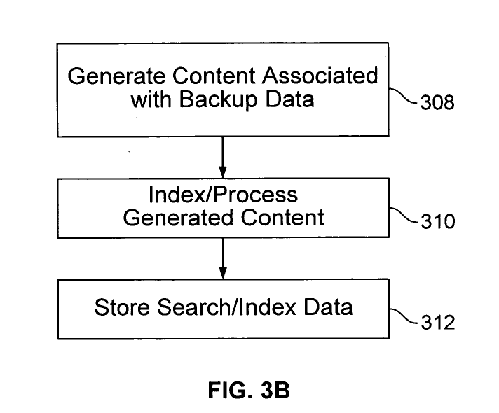

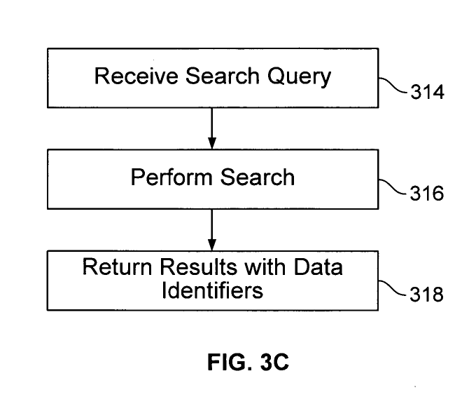

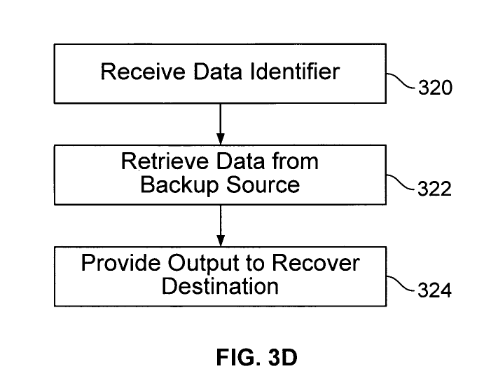

FIG. 3A is a flow chart illustrating an embodiment of a process for searching and retrieving backup data. At 302, data associated with backup is prepared for searching. Preparing might include indexing, converting, decompressing, translating, and/or transferring data. Preparing backup data for searching may be performed on a prescribed basis, periodically, and/or substantially concurrent with generation of new backup data, e.g., in connection with a backup operation. At 304, a search is performed using data associated with the backup search preparation, such as an index. Once data desired to be restored has been located through searching, at 306 data associated with one or more search results are retrieved from the backup data.

FIG. 3B is a flow chart illustrating an embodiment of a process for preparing backup data for searching. In some embodiments, the process of FIG. 3B is included in 302 of FIG. 3A. At 308, content associated with the backup data is generated. The content generation includes decompressing, converting, translating, and/or transferring at least a portion of backup data for preparing the data for search processing. At 310, the generated content is processed for searching. In some embodiments, processing for search includes generating a searchable index of the data. In some embodiments, the searchable index includes data that can be used to determine whether a data of interest is present in a set of backup data and/or where data of interest is located within a set of backup data. In some embodiments, the searchable index is used to determine where a particular data of interest is located in a set of backup data without accessing or searching the actual backup data and/or production data that has been restored using the backup data. Keywords may be generated using the content and associated with identifiers indicating the location of specific data within the backup data. The location identifier may include a file path within the backup data; a location of a file or other object on backup media; a backup media path, volume or location; or any other location data that could later be used to retrieve and restore the associated data and/or object. In some embodiments, the location identifier may be independent of any physical and logical data location and independent of type of backup data. For example, the identifier may be a unique identification number such as a uniform resource identifier (URI). The identification number corresponding to the associated data is valid even if the associated data is relocated to another physical or logical location or even if the data is converted, translated, or compressed. Processing the backup data for searching may include any processing preparation required for any search methodology. Index and keyword search methodology is merely an illustrative example. At 312, at least a portion of data generated in 310 is stored. The data stored in 312 may be stored together with the backup data or in a separate logical or physical storage unit. In some embodiments, the data stored in 312 is not stored in a storage unit. It may be stored temporarily in memory or generated every time a search is performed.

FIG. 3C is a flow chart illustrating an embodiment of a process for performing a backup data search. In some embodiments, the process of FIG. 3C is included in 304 for FIG. 3A. In some embodiments, FIG. 3C may be implemented in indexer and search engine 206 of FIG. 2. At 314, a search query is received. The search query may be sent from a backup search application. The backup search application may be a part of a backup recovery application. In some embodiments, security authentication is required before a search query is accepted. At 316, a search associated with the query is performed. Performing the search may include searching index data associated with the backup data. A search engine such as the FAST Instream may be used. At 318, the results of the search query are returned with one or more identifiers indicating the locations of specific data within the backup data. Returning the query result may include compiling multiple intermediate search results together. In some embodiments, the results are returned to a backup search and recovery application.

FIG. 3D is a flow chart illustrating an embodiment of a process for retrieving data from backup data. In some embodiments, the process of FIG. 3D is included in 306 of FIG. 3A. At 320, a location identifier associated with a data to be retrieved is received. One or more identifiers may be received. An identifier may be associated with one or files and/or directories associated with the backup data. At 322, the data is retrieved from a backup source. The backup source includes any physical or logical data storage unit, including hard drives, file system partitions, backup tapes, NAS (Network Attached Storage), SAN (Storage Area Network), any optical and magnetic storage medium, and any fixed, removable, or networked storages. Retrieving the data may include translating the identifier to a location within the backup data, locating and retrieving the data source and locating and retrieving the desired data within the data source. At 324, an output data is provided to the recover destination. The output data may be the retrieved data or the retrieved data may be decompressed, modified, converted, translated, or merged before being provided as the output data. In some embodiments, the output data is provided to an intermediate module before being provided to the recover destination.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of facilitating a search of backup data, comprising:
receiving data associated with at least a portion of the backup data; and
generating, based at least in part on the received data, a searchable index of the backup data;
wherein the searchable index includes an index data indicating a location within the backup data of an object comprising the backup data.

2. A method as recited in claim 1, wherein receiving data associated with at least a portion of the backup data includes receiving for each of one or more objects comprising the backup data a content data associated with the object and a location data indicating a location of the object within the backup data.

3. A method as recited in claim 2, wherein the searchable index is generated based at least in part on the content data and the location data.

4. A method as recited in claim 1, further comprising receiving a search request comprising query data associated with the object and using the query data and the searchable index to determine the location of the object within the backup data.

5. A method as recited in claim 4, further comprising presenting a search result associated with the object and receiving in response a request to restore the object using the backup data.

6. A method as recited in claim 5, further comprising restoring the object using the backup data.

7. A method as recited in claim 1, further comprising generating, based at least in part on the backup data, said data associated with at least a portion of the backup data.

8. A method as recited in claim 1, wherein receiving data associated with at least a portion of the backup data comprises receiving substantially contemporaneously with its generation by a backup operation a content data portion of the backup data.

9. A method as recited in claim 1, further comprising using the searchable index to determine the location of the object within the backup data without accessing the backup data.

10. A method as recited in claim 1, further comprising using the searchable index to determine the location of the object within the backup data without first using the backup data to restore a set of production data with which the backup data is associated.

11. A method as recited in claim 1, wherein the object comprises a file, directory, or other file system object.

12. A method as recited in claim 1, wherein the object may exist in one or more locations within the backup data.

13. A method as recited in claim 1, wherein the object and one or more variants thereof may exist in different respective locations within the backup data.

14. A method as recited in claim 1, wherein the object is one of a set of one or more objects comprising the backup data.

15. A method as recited in claim 1, wherein the object is one of a set of one or more objects comprising the backup data and the searchable index includes for each of said one or more objects an index data indicating a location of that object within the backup data.

16. A method as recited in claim 1, wherein the backup data comprises data generated in connection with two or more backup operations performed at different times.

17. A method as recited in claim 1, wherein generating a searchable index includes one or more of the following: decompressing backup data, converting backup data, translating backup data, transferring backup data, indexing backup data, generating keywords associated with backup data, and any processing required for data search and retrieval, on a prescribed basis, periodically, or substantially concurrent with addition, modification, and deletion of the backup data.

18. A method as recited in claim 1, wherein the backup data includes one or more of the following: backup-to-disk data, backup-to-tape data, compressed data, snapshot data, generational backup data, and backup stream data.

19. A method as recited in claim 1, wherein the searchable index is stored in one or more of the following: hard drives, NAS (Network Attached Storage), SAN (Storage Area Network), backup streams, any optical and magnetic storage medium, and any fixed or networked storages.

20. A method as recited in claim 1, wherein the searchable index is stored together with the backup data.

21. A method as recited in claim 1, wherein the location comprises a file path identifier.

22. A method as recited in claim 1, wherein the location is indicated by an identifier that is independent of any physical or logical data location and independent of type of backup data.

23. A method as recited in claim 1, wherein the object may be relocated, converted, translated, or compressed without altering the index data.

24. A method as recited in claim 1, wherein the backup data and a destination to which the object is requested to be restored exist inside a same physical storage unit.

25. A method as recited in claim 1, wherein the backup data and a destination to which the object is requested to be restored are connected together through any public or private or a combination thereof, including an Ethernet, serial/parallel bus, intranet, Internet, NAS, SAN, LAN, WAN, and other forms of connecting multiple systems and or groups of systems together.

26. A method as recited in claim 1, further including using the searchable index to generate a search result including by compiling multiple intermediate search results together.

27. A method as recited in claim 1, further comprising restoring the object to a destination storage including by one or more of the following: translating the index data to one or more locations within the backup data, locating data associated the index data, decompressing data, modifying data, converting data, translating data, and merging data.

28. A system for facilitating a search of a backup data, comprising:
a communication interface configured to receive data associated with at least a portion of the backup data; and
a processor configured to generate based at least in part on the received data, a searchable index of the backup data;
wherein the searchable index includes an index data indicating a location within the backup data of an object comprising the backup data.

29. A system as recited in claim 28, wherein the received data includes a content data associated with one or more objects comprising the at least a portion of the backup data and a location data indicating a location of the one or more objects within the backup data.

30. A system as recited in claim 28, wherein the processor is further configured to generate, based at least in part on the backup data, said data associated with at least a portion of the backup data.

31. A system as recited in claim 28, wherein the communication interface received data associated with at least a portion of the backup data substantially contemporaneously with the data generation by a backup operation a content data portion of the backup data.

32. A system as recited in claim 28, wherein the searchable index is used to determine the location of the object within the backup data without accessing the backup data.

33. A system as recited in claim 28, wherein the searchable index is used to determine the location of the object within the backup data without first using the backup data to restore a set of production data with which the backup data is associated.

34. A computer program product for facilitating a search of backup data, the computer program product being embodied in a computer readable medium and comprising computer instructions for:
receiving data associated with at least a portion of the backup data; and
generating, based at least in part on the received data, a searchable index of the backup data;
wherein the searchable index includes an index data indicating a location within the backup data of an object comprising the backup data.
